(19) United States
(12) Patent Application Publication
(10) Pub. No.: US 2016/0244319 A1
(43) Pub. Date: Aug. 25, 2016

(54) METHOD OF CUSTOM FITTING A MATTRESS

(71) Applicant: Hanseatic Bedding Products, Inc., Grand Rapids, MI (US)

(72) Inventors: Patrick A. Habertag, Ada, MI (US); Timothy A. Taig, Caledonia, MI (US)

(21) Appl. No.: 15/047,192

(22) Filed: Feb. 18, 2016

Related U.S. Application Data
(60) Provisional application No. 62/118,015, filed on Feb. 19, 2015.

(51) Int. Cl. B68G 9/00; A47C 27/20; A47C 27/06; A47C 27/14

(52) U.S. Cl. CPC B68G 9/00; A47C 27/148; A47C 27/20; A47C 27/06

(57) ABSTRACT

A method for custom fitting a mattress to the anatomy of a person includes identifying and marking anatomical landmarks on the person, transferring the markings to a mattress or support, confirming the marking locations are correct for different sleep positions, and identifying mattress zones in which the markings are located for providing relatively firm support. Relatively softer material or support may be provided in other zones of the mattress.

### CROSS REFERENCE TO RELATED APPLICATION

The present application claims the benefit of U.S. provisional application Ser. No. 62/118,015, filed Feb. 19, 2015, which is hereby incorporated herein by reference in its entirety.

### FIELD OF THE INVENTION

The present invention relates to a method of custom fitting a mattress to the anatomy of a person.

### BACKGROUND OF THE INVENTION

Various methods and principals have been applied for customizing mattresses for individual persons, to facilitate quality sleep, appropriate posture, comfort, and other benefits. It is known to vary the firmness of a mattress along its length, and to vary the level of support using springs or coils, foam, extra cushions or toppers, air, water, and the like. However, typical methodologies do not necessarily account for all orientations (sleep positions) that a person may assume during sleep. Pressure mapping techniques have been used, in which sensors are placed along a mattress and a person lies atop the sensors and mattress to generate a display or other representation of the load variation across the mattress. However, such techniques have been found to deliver false results and with inconsistent repeatability. Unsatisfactory results are also common when mattress firmness is selected according to a given person's preferences and verbal feedback during a fitting session. Moreover, methods that result in a mattress that varies in firmness at very small intervals, often do not provide sufficient comfort and support for sleeping persons as they shift to different positions.

### SUMMARY OF THE INVENTION

The present invention provides a method of custom fitting a mattress to the anatomy of a person, which method is repeatable and consistently provides desirable results. The primary objectives are increased sleep comfort and reducing the frequency and number of position changes during periods of sleep, which results in improved sleep quality and better restfulness. For example, it has been found that a custom fitted mattress constructed according to the methods of the present invention may result in approximately ⅔ reduction in the number of position changes by a given person during sleep over a period of time, as compared to the same person's average number of position changes by the same person during sleep over the same period of time on a mattress having uniform thickness along its length. In the present method, specific anatomical landmarks are identified on the person, marked on the person, and then transferred to a mattress or other support that is divided into zones for subsequent customizing of the firmness of various zones once the anatomical landmarks have been transferred to the mattress or support in at least one sleep position. The method yields repeatable analysis and results by deriving the required level of support in different areas of a mattress, which information can then be used in customizing a mattress for a particular person in multiple different sleep positions.

According to one form of the present invention, a method of custom fitting a mattress includes the steps of (i) identifying the respective locations of a person's vertebral prominens (VP), the posterior superior iliac spine (PSIS), and the posterior of the heel; (ii) designating a plurality of zones along the longitudinal length of a support, where the zones extend across at least a portion of the lateral width of the support in the lateral direction, and each zone has a dimension that is measured along the length of the support in its longitudinal direction; (iii) positioning the person in a first lying-down position on the support; (iv) marking the support with first indicia at the respective locations of the person's VP, PSIS, and heel with the person in the first lying-down position; (v) positioning the person in a second lying-down position on the support that is different from the first lying-down position; (vi) marking the support with another first indicia at least at the location of the person's heel with the person in the second lying-down position; (vii) marking the support with second indicia at a predetermined distance that is spaced longitudinally on either side of each first indicia; (viii) installing relatively firmer support material at a mattress in locations corresponding to each of the zones of the support that are marked with at least one of the first and second indicia; (ix) installing relatively softer support material at the mattress in locations corresponding to each of the zones at the support that is not marked with at least one of the first and second indicia.

In one aspect, the first lying-down position is a face-up supine position, and the second lying-down position is one of a face-down prone position and a side-laying position. Optionally, the second lying-down position is followed by the other of a prone position and a side-laying position.

In another aspect, the second lying-down position is prone, wherein the first indicia corresponding to the person's heel is marked on the mattress at the most posterior inferior part of the heel, and marking the mattress with another first indicia of the person's heel involves marking the mattress at a location at the anterior superior of the intertibiotalar space of the foot.

In still another aspect, when the second lying-down position is the side-laying position, the step of marking the mattress with the first indicia of the person's heel includes marking the mattress at the most posterior inferior part of the heel, and the step of marking the mattress with another first indicia of the person's heel includes marking the mattress at the most posterior inferior part of the heel.

In a further aspect, the first indicia comprises adhesive stickers, and the method further includes affixing the adhesive stickers to the person's VP, PSIS, and heel after identifying the respective locations of the VP, PSIS, and the heel. Optionally, marking the mattress with the first indicia includes transferring the adhesive stickers from the person to corresponding locations on the mattress.

In a still further aspect, the dimension of each zone measured along the length of the mattress or support in the longitudinal direction is approximately 8-inches.

In yet another aspect, the predetermined distance of the second indicia from respective ones of the first indicia is approximately 4-inches.

In still another aspect, marking the support includes placing a visibly distinguishable indicia directly on a surface of the support.

Thus, the method of custom fitting a mattress of the present invention results in a mattress having relatively firm support areas across a sufficient length of the mattress, under the person's heels, vertebral prominens, and posterior superior iliac spine, in order to accommodate the person in various different sleeping positions. The method provides sufficiently definite and repeatable information that can be used to provide appropriate support along sufficiently large portions of a resulting mattress, so that a given person will have desired levels of support and comfort in multiple different sleep positions.

These and other objects, advantages, purposes and features of the present invention will become apparent upon review of the following specification in conjunction with the drawings.

### BRIEF DESCRIPTION OF THE DRAWINGS

FIG. 1 is a left side elevation of an upright human form with indicia markings affixed, and a mattress or support marked in zones, for custom fitting in accordance with a method of the present invention;

FIG. 2 is a left side elevation of the human form in a supine position above the mattress;

FIG. 3 is a left side elevation of the human form in a left side laying position above the mattress;

FIG. 4 is a left side elevation of the mattress with the indicia markings transferred and added thereto;

FIG. 5 is another left side elevation of the mattress and markings of FIG. 4, labeled with firmness levels of the various mattress zones; and

FIG. 6 is a decision matrix chart depicting a pillow selection process.

### DESCRIPTION OF THE PREFERRED EMBODIMENTS

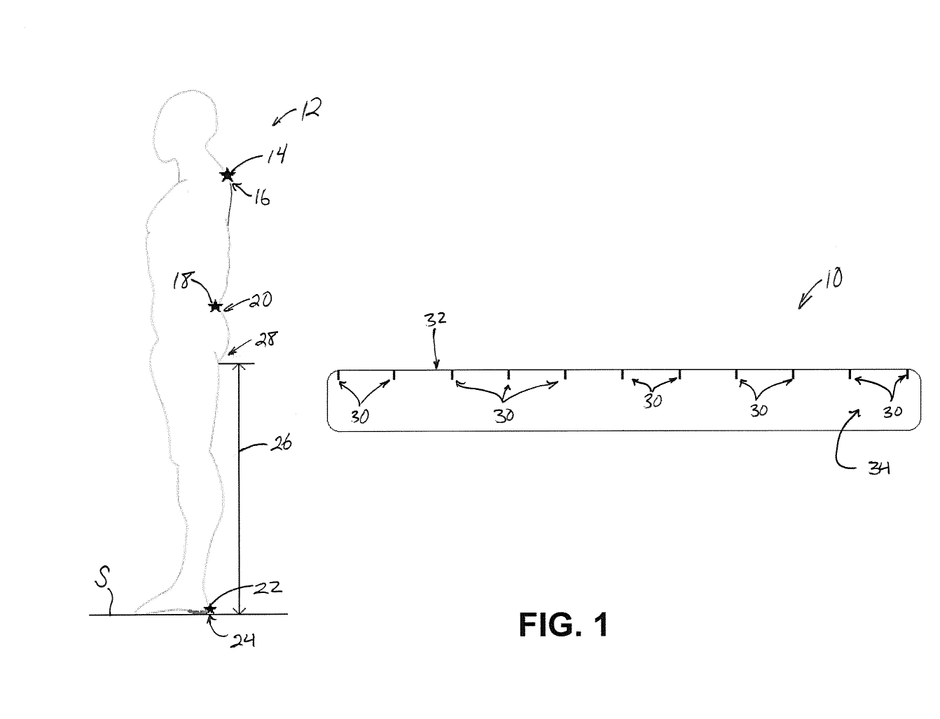

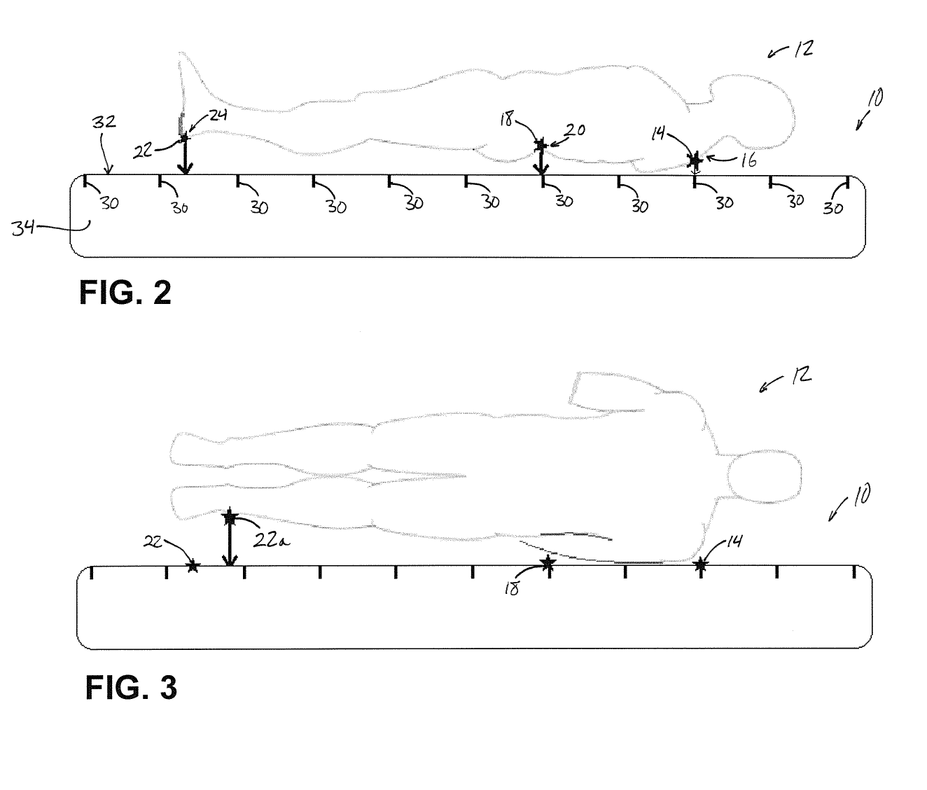

Referring now to the drawings and the illustrative embodiment depicted therein, a method is provided for custom fitting a mattress 10 to the anatomy of an individual person, represented by a human form 12 (FIGS. 1 and 2). The method generally involves a medical analysis of key parameters of the anatomy and health condition of a patient or person being fitted for the mattress, deriving the support requirements from these key parameters, transposing the parameters to the mattress, and then customizing the mattress with appropriate levels of support in the zones identified by transposing key anatomical landmarks to the mattress. The method provides a repeatable manner in which to derive appropriate support levels and locations of a mattress for a given person. Because of the proximity of the parasympathetic nervous system at the person's posterior superior iliac spine (PSIS) and vertebral prominens (VP), it is desirable to provide firm or additional mattress support at these areas in particular. The muscles and ligaments in these areas are often strained, such as due to unnatural loads from sitting in office chairs, working with the hands in overhead locations, poor posture, and the like. Supporting these areas permits the muscles and ligaments to relax substantially without strain during sleep.

At the start of the method, a VP marking or indicia 14 is placed at the vertebral prominens 16, which is the prominent vertebral spinous process located at the base of the cervical spine or neck (FIG. 1). A PSIS indicia or marking 18 is placed at the person's posterior superior iliac spine 20, which are the bilateral bony prominent structures that are posterior inferior to the iliac crest. A heel marking or indicia 22 is placed at the most posterior inferior part of the heel 24. In one embodiment, markings 14, 18, 22 are adhesive stickers that can later be removed from the person and transferred directly to mattress 10. Optionally, a height measurement 26 is measured from a floor or support surface S to the person's gluteal fold 28 for later use in choosing or setting a height of mattress 10. It is further envisioned that markings may be made at the person's anatomical landmarks and/or along the mattress or support with an ink pen or marker, an erasable or washable substance, or the like, or the markings may be entered into a computer as described below.

Optionally, mattress 10 includes zone markings or indicia 30, such as at evenly-spaced intervals along a top surface 32 and/or a side surface 34 of the mattress (FIG. 1). Once the markings 14, 18, 22 are positioned at the corresponding anatomical landmarks 16, 20, 24, person 12 lies on mattress 10 in a first lying-down position, such as the supine position of FIG. 2. Markings 14, 18, 22 are then transferred to mattress 10, such as shown with downwardly-pointing arrows in FIG. 2. The heel marking 22 is at the most posterior inferior location of the heel, and the feet are plantar flexed to position the heel marking 22 appropriately for transferring to the mattress or support. Once the markings 14, 18, 22 have been transferred to mattress 10, person 12 is repositioned at a second lying-down position, such as the left-side lying-down position of FIG. 3. At this point, an additional heel marking 22a at the posterior inferior location of the heel can be transferred to mattress 10, such as shown in FIG. 3, and will typically be spaced up the mattress in a longitudinal direction from the first heel marking 22, such as shown in FIG. 3. This process may also be repeated for another sleeping position, such as a prone or face-down sleeping position, in which the feet are plantar flexed and a heel marking at the location anterior superior of the talus (the “intertibiotalar space”) of the foot is transferred to the mattress or support.

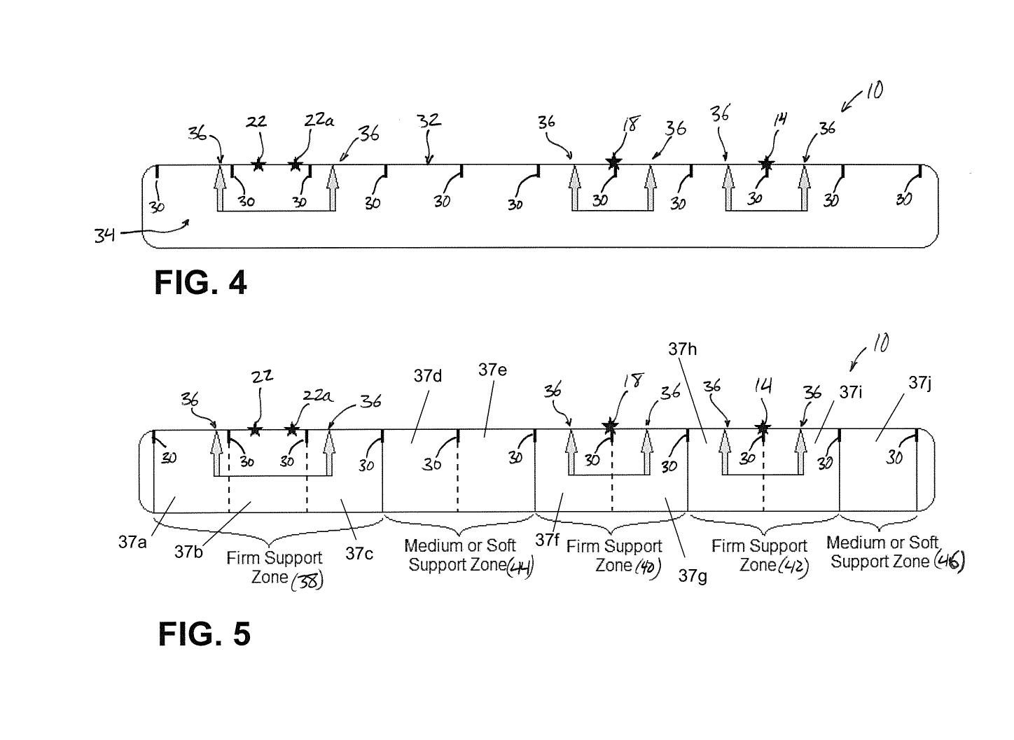

During this process, the locations of the person's VP and PSIS will be maintained at the same respective locations relative to the mattress or support, so that the corresponding locations of the markings 14, 18 will be substantially unchanged whether supine, prone or side sleeping. Once person 12 has assumed several different sleeping positions atop mattress 10 so that the locations of the markings 14, 18, 22, 22a along mattress 10 can be confirmed, second indicia 36 are marked along mattress 10 at locations that are spaced at predetermined distance (longitudinally) on either side of each marking indicia 14, 18, 22, 22a, such as shown in FIG. 4.

It will be appreciated that the drawings of FIGS. 2 and 3 are merely illustrative of the corresponding methods described herein, and are not intended to be realistic images of a person lying atop a mattress, since the drawings depict person 12 in a rigid state and elevated slightly above mattress 10. For purposes of understanding, the use of a rigid human form simplifies the drawings and is used to more clearly demonstrate the methods described herein, whereas in actual practice a person would be lying directly on the mattress in a conventional and non-rigid manner. As such, during actual implementation of the disclosed methods, a person's body will conform to the mattress or support, and assuming the mattress or support is cushioned, the mattress or support will also deflect in localized places due to gravitational loads imparted by the person's body.

Mattress 10 is considered as being made up of a series of zones 37a-j defined between a plurality of zone markings 30, such as shown in FIG. 5. In the illustrated embodiment, mattress 10 has an overall length of approximately 80-inches, and is divided into ten zones 37a-j by eleven zone markings 30 that are spaced at approximately 8-inch intervals. Each zone 37a-j is individually adjustable in firmness by changing its material composition, types of springs, foam hardness, or the like, and each zone in which one of the markings (14, 18, 22, 22a, 36) falls is designated for relatively firmer support. Examples of material properties at firmer, softer, and medium or intermediate support zones are described in more detail below.

With reference to FIG. 5, heel markings 22, 22a and the corresponding second indicia 36 fall in three separate zones 37a-c at the foot end of the mattress 10, so that these three zones will be fitted with relatively firm support to form a foot-end firm support zone 38 having a longitudinal dimension of approximately 24-inches. A relatively firm PSIS support zone 40 is centered at PSIS marking 18, and together with its corresponding second indicia 36, falls within zones 37f and 37g. A VP support zone 42 is centered at VP marking 14 and falls within zones 37h and 37i. In the illustrated embodiment, PSIS support zone 40 and VP support zone 42 each include two 8-inch zones, and therefore each has a longitudinal dimension of approximately 16-inches. In this particular example, relatively softer material is fitted at an intermediate support zone 44 made up of zones 37d and 37e located between foot end firm support zone 38 and PSIS support zone 40, while a head-end support zone 46 is made up of zone 37j located above VP support zone 42, and is also fitted with relatively soft or intermediate firmness material, springs, or the like.

It will be appreciated that the distance between zone markings 30 can be varied as desired, and is not necessarily fixed at approximately 8-inches as in the example above. However, the distance of 8-inches between each zone marking 30 has been found to permit a sufficient level of customization without creating an excessive number of zones or regions along a mattress. Similarly, the suggested distance of approximately 4-inches for each second indicia 36 from a corresponding marking (14, 18, 22, 22a) has been found to provide desirable results, but it will be appreciated that other distances and zone dimensions may be chosen, without departing from the spirit and scope of the present invention.

Once the areas of firm support are identified, the remaining zones (in the above example, intermediate zone 44 and head-end support zone 46) may be fitted with medium-firmness support material, and person 12 again lies atop mattress 10 and provides comments on any pressure points identified along the mattress. Person 12 may then rotate to other lying down positions, typically including supine, prone, and side-laying positions, to identify any remaining pressure points along the mattress. If uncomfortable pressure points are identified in intermediate support zone 44 and/or head-end support zone 46, medium-firmness material may be exchanged for soft-firmness material in order to reduce or eliminate discomfort. For example, locations along person 12 where body weight is relatively high, such as in the pelvic region, may tend to require softer support materials, whereas areas of relatively low body weight are more likely to require medium-firmness support materials. Once the varying firmness of mattress 10 is set across the various zones, mattress height is selected so that top surface 32 will be approximately the same height above floor surface S as the person's gluteal fold 28, such as shown in FIG. 1. Mattress height is typically set with top surface 32 between approximately 1-inch above to 2-inches below the height 26 of gluteal fold 28.

It will be appreciated that a custom-fitted mattress is built up from a plurality of modules corresponding to zones that are oriented laterally and arranged along the length of the mattress, with each module having a selected firmness level. The modules may be built up using foam, coil springs, air springs, or the like, or a combination of materials. For example, three different firmness modules may be sufficient to provide desired levels of body support along the length of a mattress, ranging firm to soft, with an intermediate or medium firmness module that is in between firm and soft. When foam is the primary component of the modules, the material of the soft modules may have, for example, a material density of approximately 28 kg/m̂3, and may compress by approximately 40% from their uncompressed thickness (i.e., retain 60% of their uncompressed thickness) under a compression load or pressure of approximately 30 kPa. The material of the firm modules may have, for example, a material density of approximately 37 kg/m̂3, and may compress by approximately 40% from their uncompressed thickness (i.e., retain 60% of their uncompressed thickness) under a compression load or pressure of approximately 45 kPa. The material of the medium or intermediate firmness modules may have, for example, a material density of approximately 40 kg/m̂3, and may compress by approximately 40% from their uncompressed thickness (i.e., retain 60% of their uncompressed thickness) under a compression load or pressure of approximately 37 kPa.

Although the method described above uses a mattress for custom fitting, in which the firmness of the mattress in different zones 37a-j is readily adjustable during a customization process, it will be appreciated that substantially any type of support may be used for transferring markings and thereby determining which zones of a mattress should be fitted with relatively firm material or relatively softer material. It is further envisioned that the method may be at least partially computer implemented, such as by observing the locations of indicia 14, 18, 22 along a mattress or support on which a person is lying, entering these locations into a computer program, and then observing and recording any changes to the locations of the indicia as the person changes to different sleeping positions. In such an arrangement, the second indicia markings can be automatically calculated by the computer and used to generate the recommended zones for which firm support is recommended, without actually transferring adhesive stickers or other markings or indicia to an actual mattress or other support.

The resulting mattress has varying levels of firmness along its length, with firmness being changed typically at 8-inch intervals using modules or inserts measuring 8-inches in the longitudinal direction of the mattress, although it is envisioned that other intervals are also possible. The mattress will typically have the firmest modules or inserts in three areas, generally corresponding to the upper back and lower neck, the hips, and the heels, with medium or softer or lower firmness modules or inserts located in between the three firmest areas, and also extending longitudinally outboard of the firmest areas corresponding to the heels and to the upper back and lower neck.

Accordingly, the mattress-fitting method of the present invention provides a custom fit mattress that provides relatively firm support in three key areas or regions of a person's anatomy, and which provides comfort to the person in all common sleeping positions, while avoiding a situation in which the mattress is so closely tailored to body position and orientation that only one position is truly comfortable and correct, while resulting in a reduced number and frequency of sleep position changes for a given person on the custom fitted mattress as compared to a traditional constant-firmness mattress. The resulting product facilitates appropriate posture and comfort during sleep in substantially any position that a person is likely to assume during sleep.

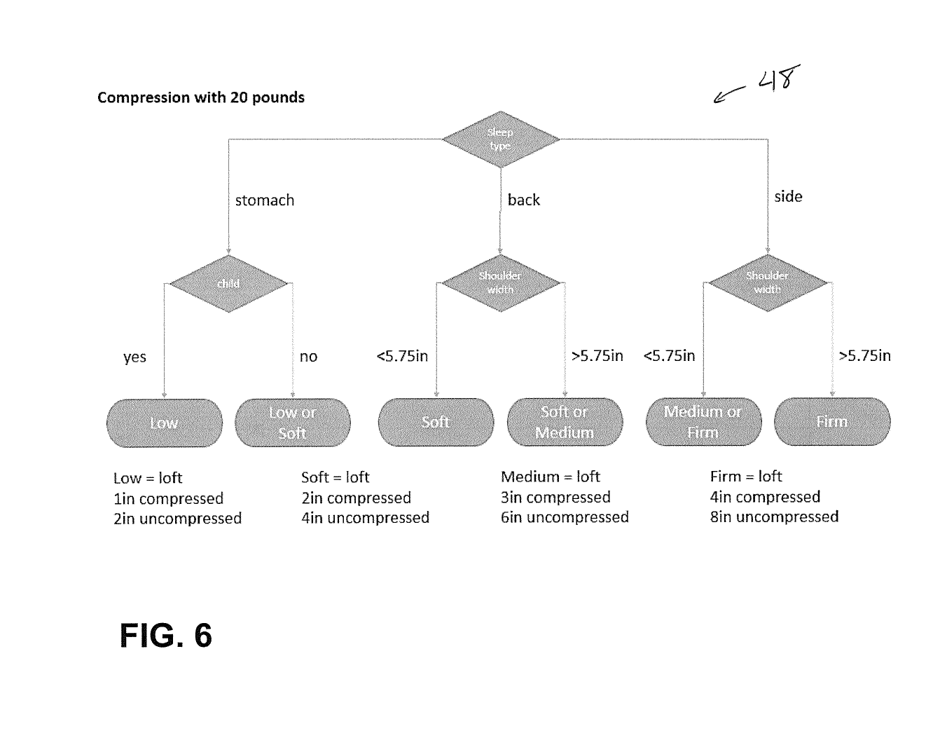

Optionally, a pillow may be chosen for a given person according to sleep position (supine, prone, or side-laying) and shoulder width, with the objective of permitting the upper spine or neck area to relax during sleep by maintaining a relatively straight orientation without bending, thereby limiting or preventing stress to muscles and ligaments in the neck area for a given sleep position. For the following examples of pillows and lofts, it should be understood that the compressed state refers to the thickness of the pillow in the area where approximately 20-pounds of weight is applied across the surface area of a person's head and upper shoulders. Pillow selection may be accomplished according to a decision tree 48 (FIG. 6) in which stomach (prone) sleepers who are children are provided with a lower loft (i.e., lower “fill power”) pillow having an uncompressed thickness of approximately 2-inches and a compressed thickness of approximately 1-inch, whereas adult prone sleepers may be provided with a soft loft pillow having an uncompressed thickness of approximately 4-inches and a compressed thickness of approximately 2-inches.

For back (supine) sleepers having a shoulder width of less than approximately 5.75 inches, a soft loft pillow having an uncompressed thickness of approximately 4-inches and a compressed thickness of approximately 2-inches is selected, while a supine sleeper having a shoulder width greater than about 5.75 inches is provided a pillow having medium loft and an uncompressed thickness of approximately 6-inches and a compressed thickness of approximately 3-inches. Side-laying sleepers having a shoulder width less than approximately 5.75 inches are provided a medium or firm loft pillow having an uncompressed thickness of approximately 8-inches and a compressed thickness of approximately 4-inches, whereas a side sleeper having a shoulder width greater than 5.75 inches is provided a firm loft pillow having an uncompressed thickness of approximately 8-inches and a compressed thickness of approximately 4-inches.

Side-laying sleepers having a shoulder width less than approximately 5.75-inches are provided a medium or firm loft pillow having an uncompressed thickness of approximately 8-inches. The material of the medium loft pillow is as described above, whereas the firm loft pillow may have, for example, a material density of approximately 37 kg/m̂3, and is compressible by approximately 40% from its uncompressed thickness (i.e., compressed to 4.8-inches thick from an 8-inch uncompressed thickness) under a compression load or pressure of approximately 45 kPa. A side sleeper having a shoulder width greater than 5.75-inches is provided a firm loft pillow having an uncompressed thickness of approximately 8-inches, and material properties as described above.

The resulting mattress, or mattress and pillow combination, is custom fitted to a measured individual to achieve improved sleep quality, such as may be indicated by a reduction in the number and frequency of position changes during periods of sleep. Although it is envisioned that a given person's individual perceptions may be used to make selections as to the relative firmness of one or more of the firm, soft, and medium or moderate firmness mattress modules, the regions or zones of the mattress designated for relatively firm, soft, or moderate firmness modules are determined by measurement and calculations according to the methods described herein, and thus are substantially independent of a given person's perception of comfort while lying awake on a mattress.

Changes and modifications in the specifically-described embodiments may be carried out without departing from the principles of the present invention, which is intended to be limited only by the scope of the appended claims as interpreted according to the principles of patent law including the doctrine of equivalents.

The embodiments of the invention in which an exclusive property or privilege is claimed are defined as follows:

1. A method of custom fitting a mattress to the anatomy of a person, said method comprising:
identifying the respective locations of at least three anatomical landmarks spaced lengthwise along the person, at least one of the anatomical landmarks being identified along a portion of the foot;
designating a plurality of zones arranged along the length of a support, each zone having substantially the same dimension measured along the length of the support in the longitudinal direction;
positioning the person in a first lying-down position on the support;
marking the support with first indicia at the respective locations of the person's identified anatomical landmarks with the person in the first lying-down position;
positioning the person in a second lying-down position on the support, wherein in the second lying-down position the person is rotated at least about 90-degrees about a length axis through the sagittal plane from the first lying-down position;
marking the support with another first indicia at least at the location of the identified portion of the foot with the person in the second lying-down position;
marking the support with second indicia at a predetermined distance spaced longitudinally on either side of each first indicia; and
constructing a mattress by:
installing relatively firm support modules in locations corresponding to each of the zones of the support that is marked with at least one of the first and second indicia; and
installing relatively soft support modules, which are more compressible than the firm support material under a given load, in locations corresponding to each of the zones of the support that is not marked with at least one of the first and second indicia.

2. The method of claim 1, wherein said identifying the respective locations of the at least three anatomical landmarks comprises identifying and marking the vertebral prominens (VP), the posterior superior iliac spine (PSIS), and the heel.

3. The method of claim 1, wherein said positioning the person in the first lying-down position comprises positioning the person in a supine position, and wherein said positioning the person in the second lying-down position comprises positioning the person in one of a prone position and a side-laying position.

4. The method of claim 3, wherein said positioning the person in the second lying-down position comprises positioning the person in the prone position, said marking the mattress with the first indicia of the person's heel comprises marking the mattress at the most posterior inferior part of the heel, and said marking the mattress with another first indicia of the person's heel comprises marking the mattress at the location that is anterior superior of the intertibiotalar space of the foot.

5. The method of claim 3, wherein said positioning the person in the second lying-down position comprises positioning the person in the side-laying position, said marking the mattress with the first indicia of the person's heel comprises marking the mattress at the most posterior inferior part of the heel, and said marking the mattress with another first indicia of the person's heel comprises marking the mattress at the most posterior inferior part of the heel

6. The method of claim 1, wherein the first indicia comprise adhesive stickers, said method further comprising affixing the adhesive stickers to the person's VP, PSIS, and heel after identifying the respective locations of the VP, the PSIS, and the heel.

7. The method of claim 6, wherein said marking the mattress with the first indicia comprises transferring the adhesive stickers from the person to the mattress.

8. The method of claim 1, wherein the dimension of each zone measured along the length of the mattress in the longitudinal direction is approximately 8-inches.

9. The method of claim 8, wherein the predetermined distance of the second indicia from respective ones of the first indicia is approximately 4-inches.

10. The method of claim 1, wherein said marking the support comprises placing a visibly distinguishable indicia directly on a surface of the support.

11. A method of custom fitting a mattress to the anatomy of a person, said method comprising:
identifying the respective locations of at least three anatomical landmarks spaced lengthwise along the person;
designating a plurality of zones arranged along the length of a support, the zones extending across at least a portion of the width of the support in the lateral direction, and each zone having a dimension measured along the length of the support in the longitudinal direction;
positioning the person in a first lying-down position on the support;
marking the support with first indicia at the respective locations of the person's anatomical landmarks with the person in the first lying-down position;
positioning the person in a second lying-down position on the support that is different from the first lying-down position;
marking the support with another first indicia at least at the location of the person's heel with the person in the second lying-down position;
marking the support with second indicia at a predetermined distance spaced longitudinally on either side of each first indicia;
installing relatively firm support material at a mattress in locations corresponding to each of the zones of the support that are marked with at least one of the first and second indicia; and
installing relatively soft support material, that is softer than the firm support material, at the mattress in locations corresponding to each of the zones of the support not marked with at least one of the first and second indicia.

12. The method of claim 11, wherein said identifying the respective locations of the at least three anatomical landmarks comprises identifying the vertebral prominens (VP), the posterior superior iliac spine (PSIS), and the heel.

13. The method of claim 11, wherein said positioning the person in the first lying-down position comprises positioning the person in a supine position, and wherein said positioning the person in the second lying-down position comprises positioning the person in one of a prone position and a side-laying position.

14. The method of claim 13, wherein said positioning the person in the second lying-down position comprises positioning the person in the prone position, said marking the mattress with the first indicia of the person's heel comprises marking the mattress at the most posterior inferior part of the heel, and said marking the mattress with another first indicia of the person's heel comprises marking the mattress at the location that is anterior superior of the intertibiotalar space of the foot.

15. The method of claim 13, wherein said positioning the person in the second lying-down position comprises positioning the person in the side-laying position, said marking the mattress with the first indicia of the person's heel comprises marking the mattress at the most posterior inferior part of the heel, and said marking the mattress with another first indicia of the person's heel comprises marking the mattress at the most posterior inferior part of the heel

16. The method of claim 11, wherein the first indicia comprise adhesive stickers, said method further comprising affixing the adhesive stickers to the person's VP, PSIS, and heel after identifying the respective locations of the VP, the PSIS, and the heel.

17. The method of claim 16, wherein said marking the mattress with the first indicia comprises transferring the adhesive stickers from the person to the mattress.

18. The method of claim 11, wherein the dimension of each zone measured along the length of the mattress in the longitudinal direction is approximately 8-inches, and wherein the predetermined distance of the second indicia from respective ones of the first indicia is approximately 4-inches.

19. The method of claim 11, wherein said marking the support comprises placing a visibly distinguishable indicia directly on a surface of the support.

20. A custom-fitted mattress prepared by a process comprising the steps of:
identifying the respective locations of at least three anatomical landmarks spaced lengthwise along a person;
designating a plurality of zones arranged along the length of a support, the zones extending across at least a portion of the width of the support in the lateral direction, and each zone having a dimension of about 8-inches measured along the length of the support in the longitudinal direction;
positioning the person in a first lying-down position on the support;
marking the support with first indicia at the respective locations of the person's anatomical landmarks with the person in the first lying-down position;
positioning the person in a second lying-down position on the support that is different from the first lying-down position;
marking the support with another first indicia at least at the location of the person's heel with the person in the second lying-down position;
marking the support with second indicia spaced longitudinally by about 4-inches on either side of each first indicia;
installing a plurality of relatively firm support modules at the mattress, each of the relatively firm support modules having a dimension of about 8-inches measured in longitudinal direction of the mattress, in locations corresponding to each of the zones of the support that are marked with at least one of the first and second indicia; and
installing relatively soft support modules at the mattress in locations corresponding to each of the zones of the support not marked with at least one of the first and second indicia, wherein the relatively soft support modules are softer than the firm support material, and each of the relatively soft support modules having a dimension of about 8-inches measured in the longitudinal direction of the mattress.
